(19) United States
(12) Patent Application Publication
(10) Pub. No.: US 2022/0252706 A1
(43) Pub. Date: Aug. 11, 2022

(54) Distance Measurement Device

(71) Applicant: Nippon Telegraph and Telephone Corporation, Tokyo (JP)

(72) Inventors: Masahiro Ueno, Tokyo (JP); Yuichi Akage, Tokyo (JP); Soichi Oka, Tokyo (JP)

(21) Appl. No.: 17/622,484

(22) PCT Filed: Jun. 26, 2019
(86) PCT No.: PCT/JP2019/025380

§ 371 Date: Dec. 23, 2021

(51) Int. Cl. G01S 7/4915; G01S 17/32; G01S 7/4913; G01S 7/4911

(52) U.S. Cl. CPC G01S 7/4915; G01S 7/4911; G01S 7/4913; G01S 17/32

(57) ABSTRACT

A distance measurement device includes a skew measurement unit that measures a skew between channels of an ADC based on a criterion signal and a first detection signal and outputs a skew signal, a correction unit that uses the skew signal to correct a time difference between a first peak time of a first peak included in a waveform of a reference signal and a second peak time of a second peak corresponding to the first peak included in a waveform of a second detection signal, and a distance measurement unit that obtains a distance to an object for each first peak timased on the corrected time difference and outputs a distance signal.

### CROSS-REFERENCE TO RELATED APPLICATION

This application is a national phase entry of PCT Application No. PCT/JP2019/025380, filed on Jun. 26, 2019, which application is hereby incorporated herein by reference.

### TECHNICAL FIELD

The present invention relates to a distance measurement device, and more particularly, to a distance measurement technology using a time-of-flight scheme.

### BACKGROUND

In the related art, a time of flight (TOF) scheme has been known as a technology for measuring a distance to an object. In a distance measurement process using the TOF scheme, a laser is caused to emit light, and a time of flight until the laser light is reflected by an object and returned is measured and multiplied by a speed of light so that a distance to the object is derived (see Non Patent Literature 1).

As a specific example of the distance measurement technology using the TOF scheme, Non Patent Literature 2 discloses a distance measurement device that measures a position of an underground excavator used for construction of a pipeline such as a sewer pipe using the TOF scheme without excavating a ground surface.

Further, in the technologies described in Non Patent Literatures 1 and 2, it is necessary to measure a time difference between two signals, namely a reference signal serving as a criterion for measurement of a time and a detection signal obtained by photoelectrically converting light reflected and returned by a surface of an object that is a measurement target. For example, the two signals are captured using an analog-to-digital converter (ADC) with two channels. In this case, when a time difference between the two signals is Δt, a measured value L of the distance to the object is expressed as cΔt/2. Here, c is a speed of light.

Such a distance measurement device of the related art has a problem in that accurate distance measurement cannot be performed when a timing difference (skew) between the channels of the ADC fluctuates with time. That is, when there is a skew in a signal acquisition time between the channels of the ADC, a measured value L of the distance fluctuates accordingly. For example, when the detection signal is delayed by δt with respect to the reference signal due to a skew between the channels of the ADC, a measured value L′ of the distance to the object is c(Δt+δt)/2, which differs by cδt/2.

In this case, when the skew δt is a fixed value, the skew δt is measured in advance, and the skew δt measured in advance is subtracted from the time difference between the reference signal and the detection signal at the time of distance measurement so that a correct distance can be obtained. However, there is a problem that, when the skew δt differs for each signal acquisition, the measured value of the distance differs for each signal acquisition, and the accuracy of the obtained distance is reduced.

### CITATION LIST

### Non Patent Literature

Non Patent Literature 1: Koji Oishi, Mitsuhiko Ota, Hiroyuki Matsubara, “Measurement of Time of Flight for Multiple Reflected Light Using FPGA in Laser Radar”, Institute of Electronics, Information and Communication Engineers, 2018 Institute of Electronics, Information and Communication Engineers General Conference Electronics Lecture Proceedings 2, P. 38, C-12-3, published Mar. 6, 2018.

Non Patent Literature 2: Tooru Kodaira, Shogo Yagi, Fujiura Kazuo, Mori Jiro, Watanabe Takeshi, “Optical Sweeping Position Measurement System with Wavelength Sweeping Technology”, Optical and Electro-Optical Engineering Contact, Vol. 55, No. 8, pp. 18-27, published Aug. 20, 2017

### SUMMARY

### Technical Problem

The embodiments of the present invention have been made to solve the above-described problems, and an object of the present invention is to provide a distance measurement device and a distance measurement method capable of measuring a distance to an object with high accuracy even when a timing difference (skew) between channels of an ADC fluctuates with each signal acquisition.

### Means for Solving the Problem

In order to solve the above-described problem, a distance measurement device according to an embodiment of the present invention includes a first photodetector configured to receive a part of light of which the intensity has been periodically modulated as reference light and convert the light to a first reference signal; a second photodetector configured to detect reflected light obtained by the light being reflected from a surface of an object serving as a measurement target and convert the reflected light to a first detection signal; an adder configured to add a first criterion signal to each of the first reference signal and the first detection signal and output a second reference signal and a second detection signal; an analog-to-digital converter including a first AD converter configured to perform AD conversion on the second reference signal and output a third digital reference signal, and a second AD converter configured to perform AD conversion on the second detection signal and outputs a third digital detection signal; a first filter configured to extract a fourth reference signal based on the reference light and a second criterion signal based on the first criterion signal from the third reference signal; a second filter configured to extract a fourth detection signal based on the reflected light and a third criterion signal based on the first criterion signal from the third detection signal; a skew measurement unit configured to measure a skew, which is a timing difference between the first AD converter and the second AD converter based on the second criterion signal and the third criterion signal, and output a skew signal indicating the measured skew; a correction unit configured to correct a first time difference between a first peak time of a first peak included in a waveform of the fourth reference signal and a second peak time of a second peak corresponding to the first peak included in a waveform of the fourth detection signal, using the skew signal; and a distance measurement unit configured to obtain a distance to the object for each first peak time based on the corrected first time difference and output a distance signal.

### Effects of Embodiments of the Invention

According to embodiments of the present invention, a skew that is a timing difference between the first AD converter and the second AD converter is measured, and the measured skew is used for correction of a first time difference between the first peak time of the first peak included in the waveform of the fourth reference signal based on reference light subjected to AD-conversion in the first AD converter and the second peak time of the second peak corresponding to the first peak included in the waveform of the fourth detection signal based on the reflected light reflected from the object that is a measurement target subjected to AD-conversion in the second AD converter. Thus, even when a time difference (skew) between channels of an ADC fluctuates with each signal acquisition, the distance to the object can be measured with high accuracy.

### BRIEF DESCRIPTION OF THE DRAWINGS

FIG. 1 is a block diagram illustrating a configuration of a distance measurement device according to an embodiment of the present invention.

FIG. 2 is a circuit diagram illustrating an example of an adder according to the present embodiment.

FIG. 3 is a diagram illustrating an operation of the adder according to the present embodiment.

FIG. 4 is a diagram illustrating an operation of a skew measurement unit according to the present embodiment.

FIG. 5 is a diagram illustrating an operation of a distance measurement unit according to the present embodiment.

FIG. 6 is a block diagram illustrating a configuration example of the distance measurement unit according to the present embodiment.

FIG. 7 is a diagram illustrating an operation of a correction unit according to the present embodiment.

FIG. 8 is a diagram illustrating an operation of a time-angle conversion unit according to the present embodiment.

FIG. 9 is a block diagram illustrating an example of a computer configuration that implements a signal processing device according to the present embodiment.

FIG. 10 is a flowchart illustrating an operation of the distance measurement device according to the present embodiment.

FIG. 11 is a diagram illustrating a distance signal before correction according to the present embodiment.

FIG. 12 is a diagram illustrating a distance signal before correction according to the present embodiment.

FIG. 13 is a diagram illustrating a distance signal after correction according to the present embodiment.

FIG. 14 is a diagram illustrating a distance signal after correction according to the present embodiment.

FIG. 15 is a diagram illustrating an effect of the distance measurement device according to the present embodiment.

FIG. 16 is a diagram illustrating an effect of the distance measurement device according to the present embodiment.

### DETAILED DESCRIPTION OF ILLUSTRATIVE EMBODIMENTS

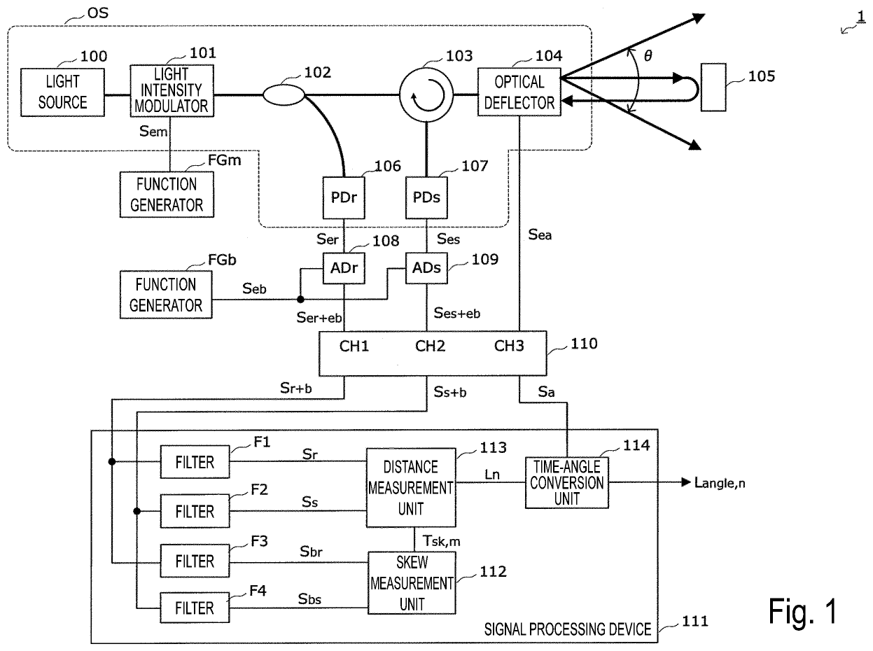

Hereinafter, preferred embodiments of the present invention will be described in detail with reference to FIGS. 1 to 16.

FIG. 1 is a block diagram illustrating a configuration of a distance measurement device 1 according to an embodiment of the present invention. As illustrated in FIG. 1, the distance measurement device 1 according to the present embodiment measures a distance from the distance measurement device 1 to an object 105 using a TOF scheme. More specifically, the distance measurement device 1 measures a difference between a time of flight from emission of light from a coupler 102 to reception of reflected light reflected on a surface of the object 105, which is a measurement target, by a photodetector PDs 107 and a time of flight from the emission of the light from the coupler 102 to reception of the light by a photodetector PDr 106 to obtain the distance from the distance measurement device 1 to the object 105.

As illustrated in FIG. 1, the distance measurement device 1 includes a light source 100, a light intensity modulator 101, a coupler 102, a circulator 103, an optical deflector 104, the photodetector (a first photodetector) (hereinafter referred to as “PDr”) 106, the photodetector (a second photodetector) (hereinafter referred to as “PDs”) 107, an adder (hereinafter referred to as “ADr”) 108, an adder (hereinafter referred to as “ADs”) 109, an analog-to-digital converter (ADC) 110, and a signal processing device tn. The coupler 102 is used as an optical splitter that splits light. Further, function generators FGm and FGb are provided outside the distance measurement device 1.

The light source 100, the light intensity modulator tot, the coupler 102, the circulator 103, the optical deflector 104, the PDr 106, and the PDs 107 constitute an optical system OS included in the distance measurement device 1.

The light source 100 emits light having a temporally constant intensity toward the object 105. As the light source 100, for example, a CW light source can be used.

The light intensity modulator 101 periodically modulates the intensity of the light emitted from the light source 100. More specifically, the intensity of the light of the light source 100 is modulated with a periodic modulation signal Sₑₘ such as a pulse wave or a sine wave that is generated by the function generator FGm. The intensity of the light emitted from the light source 100 is periodically modulated and incident on the optical deflector 104 to be described below.

The coupler 102 splits the light output from the light intensity modulator tot into a reference optical path and an object optical path. One of the light split by the coupler 102 is input to the PDr 106 on the reference optical path, and the other light is radiated to the object 105 via the circulator 103 and the optical deflector 104 on the object optical path.

The circulator 103 splits light that travels in opposite directions on the optical path. More specifically, the circulator 103 splits light emitted from the coupler 102 and radiated to the object 105 and light reflected and returned from the object 105.

The optical deflector 104 deflects an optical axis of light that is incident from the light source 100 and of which the intensity is periodically modulated by the light intensity modulator 101, and emits resultant light. More specifically, the optical deflector 104 deflects the light that is emitted from the light source 100, of which the intensity is modulated with a sine wave or the like by the light intensity modulator 101, and that is incident through the coupler 102 and the circulator 103, and emits resultant light. Hereinafter, the optical deflector 104 changing the optical axis of the incident light and emitting the resultant light is referred to as “deflecting the light”.

The optical deflector 104 deflects the light from the light intensity modulator 101 in a preset range of a deflection angle. As the optical deflector 104, for example, a galvanometer mirror, a polygon mirror, and a deflector using a potassium niobate tantalate (KTN) crystal can be used. A deflection angle θ in the optical deflector 104 can be set to be in a desired deflection angle range according to a design of a mirror or under control of a drive device (not illustrated) included in the optical deflector 104.

The optical deflector 104 deflects and emits the light emitted from the light intensity modulator 101 to scan the object 105 and the space around the object 105 (spatially swept, that is, deflected) with the light so that the light is reflected by the object 105 that is a distance measurement target. Each time the optical deflector 104 performs scanning with the light obtained by emitting the light from the light intensity modulator 101 in the set range of deflection angle θ, the reflected light from the object 105 is detected by the PDs 107 to be described below.

The PDs 107 detects the reflected light from the object 105 via the circulator 103 and converts the reflected light to a detection signal Sₑₛ (hereinafter referred to as a “first detection signal Sₑₛ”) that is an analog signal.

The PDr 106 detects the reference light that is emitted from the light source 100, of which the intensity is periodically modulated by the light intensity modulator tot, and which is split into the reference optical path by the coupler 102, and converts the reference light to a reference signal Sₑᵣ (hereinafter referred to a “first reference signal Sₑᵣ”) that is an analog signal.

The ADr 108 adds an analog criterion signal S_{eb} (hereinafter referred to as a “first criterion signal”) generated by a function generator FGb to the first reference signal Sₑᵣ, and outputs a second reference signal S_{er+eb} as an addition result.

The ADs 109 adds the first criterion signal S_{eb} that is an analog signal generated by the function generator FGb to the first detection signal Sₑₛ. The ADs 109 outputs a second detection signal S_{es+eb} that is a result of an addition operation.

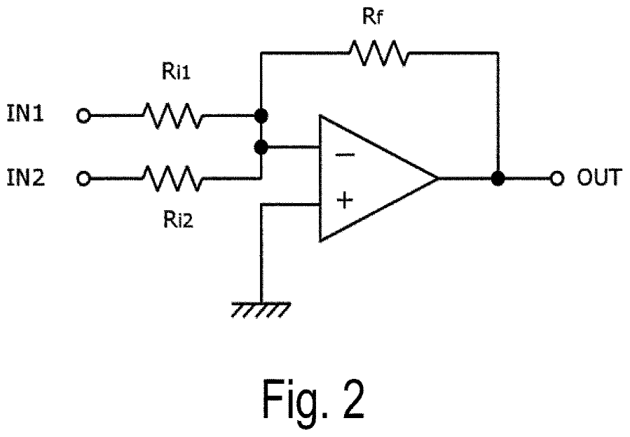

The ADr 108 and the ADs 109 can include an analog adder using an operational amplifier as illustrated in FIG. 2. Because the analog adder illustrated in FIG. 2 uses an inverting amplifier, an output thereof has an inverted polarity with respect to an input. Specifically, when a voltage of an input IN1 of the analog adder illustrated in FIG. 2 is V1 and a voltage of an input IN2 is V2, an output voltage Vₒᵤₜ is expressed as −R_{f}(V1/Rᵢ₁+V2/Rᵢ₂). Thus, the input voltages V1 and V2 and the output voltage Vₒᵤₜ have polarities inverted from each other. Here, R_{f} is a feedback resistor, and Rᵢ₁ and Rᵢ₂ are input resistors.

The ADr 108 and the ADs 109 may output the output voltage Vₒᵤₜ of which the polarity is inverted, but a configuration in which an inverting amplifier (not illustrated) is provided on the output side of the analog adder to align the polarity of the output voltage Vₒᵤₜ with the polarity of the input voltages V1 and V2 may be adopted.

In the analog adder illustrated in FIG. 2, when R_{f}=Rᵢ₁-=Rᵢ₂, a relationship Vₒᵤₜ=−(V1+V2) is obtained. In this case, there is an advantage that a design of the analog adder is simplified. Further, when resistance values of the input resistors Rᵢ₁ and Rᵢ₂ are decreased, a cutoff frequency of a low-pass filter developed due to a capacitance on the input side of the operational amplifier becomes a high frequency, so that high frequency components of the input signals IN1 and IN2 can also be added by an adder circuit. For example, the resistances of the input resistors Rᵢ₁ and Rᵢ₂ can be 50 [Ω].

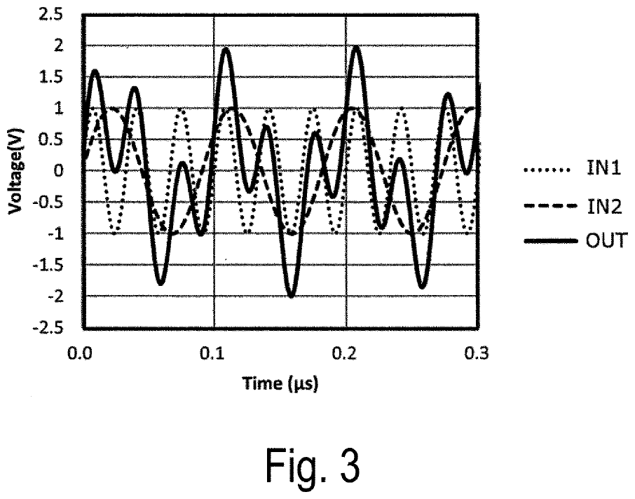

FIG. 3 illustrates a relationship between the input signals IN1 and IN2 and an output signal OUT in each of the ADr 108 and ADs 109 including the analog adder circuit illustrated in FIG. 2. In an example of FIG. 3, the input signal IN1 is a sine wave having a frequency of 30 [MHz], and the input signal IN2 is a sine wave having a frequency of 11 [MHz]. The output signal OUT is a signal obtained by adding these signals.

Thus, the ADr 108 inputs the second reference signal S_{er+eb}, which is a sum of the first criterion signal S_{eb} and the first reference signal Sₑᵣ that is a reference signal to the channel CH1 of an ADC 110. Further, ADs 109 inputs the second detection signal S_{es+eb}, which is a sum of the first criterion signal S_{eb} and the first detection signal Sₑₛ that is a detection signal to the channel CH2 of the ADC 110.

Next, a configuration of the ADC 110 will be described.

The ADC no includes three channels, and converts an analog input signal to a digital signal, and outputs the digital signal. The digital signal converted and output by the ADC 110 for each channel is input to the signal processing device 111.

The second analog reference signal S_{er+eb} input to the channel CH1 (a first AD converter) is converted to a third digital reference signal S_{r+b} and input to the filters F1 and F3 to be described below. The second detection signal S_{es+eb} input to the channel CH2 (a second AD converter) is also converted to a third digital detection signal S_{s+b} and input to the filters F2 and F4. Further, an angle signal Sₑₐ (hereinafter referred to as a “first angle signal S ea”), which is an analog signal indicating a deflection angle of the optical deflector 104, is input to the channel CH3, converted to a digital angle signal Sₐ (hereinafter referred to as a “second angle signal Sₐ”), and input to the time-angle conversion unit 114 to be described below.

The signal processing device tit includes the filters F1, F2, F3, F4, a skew measurement unit 112, a distance measurement unit 113, and the time-angle conversion unit 114. The signal processing device 111 receives the signals output from the respective channels of the ADC 110 as inputs, and calculates a distance L_{angle, n} to the object 105 for each deflection angle θ.

The filters F1, F2, F3, and F4 filter the third reference signal S_{r+b} and the third detection signal S_{s+b}, and separates to output respective predetermined signals included in the third reference signal S_{r+b} and the third detection signal S_{s+b}.

The filters F1 and F3 (first filters) extract a signal Sᵣ based on the reference light (hereinafter referred to as a “fourth reference signal Sᵣ”) and a signal S_{br} based on the first criterion signal S_{eb} (hereinafter referred to as a “second criterion signal S_{br}”) from the third reference signal S_{r+b}.

The filter F1 is a filter that passes a frequency component of the fourth reference signal Sᵣ, and separates the fourth reference signal Sᵣ from the input third reference signal S_{r+b} to output the fourth reference signal Sᵣ. The separated fourth reference signal Sᵣ is input to the distance measurement unit 113.

The filter F3 is a filter that passes a frequency component of the second criterion signal S_{br} regarding the first criterion signal S_{eb} generated by the function generator FGb, and separates the second criterion signal S_{br} from the input third reference signal S_{r+b} to output the second criterion signal S_{br}. The separated second criterion signal S_{br} is input to the skew measurement unit 112.

The filters F2 and F4 (second filters) extract a signal Sₛ based on the reflected light (hereinafter referred to as a “fourth detection signal Sₛ”) and a signal S_{bs} based on the first criterion signal S_{eb} (hereinafter referred to as a “third criterion signal S_{bs}”) from the third detection signal S_{s+b}.

The filter F2 is a filter that passes a frequency component of the fourth detection signal Sₛ, and separates the fourth detection signal Sₛ from the input third detection signal S_{s+b} to output the fourth detection signal Sₛ. The separated fourth detection signal Sₛ is input to the distance measurement unit 113.

The filter F4 is a filter that passes a frequency component of the third criterion signal S_{bs} based on the first criterion signal S_{eb} generated by the function generator FGb, and separates the third criterion signal S_{bs} from the input third detection signal S_{s+b} to output the third criterion signal S_{bs}. The separated third criterion signal S_{bs} is input to the skew measurement unit 112.

Here, configurations of the filters F1, F2, F3, and F4, the modulation signal Sₑₘ generated by each of the function generators FGm and FGb, and the first criterion signal S_{eb} will be described in more detail.

The modulation signal Sₑₘ for modulating the intensity of the light emitted from the light source 100, and the first criterion signal S_{eb} input to the ADr 108 and the ADs 109 and added to or superimposed on the first reference signal Sₑᵣ and the first detection signal Sₑₛ are electrical signals having signal waveforms that can be separated by the filters F1, F2, F3, and F4. In the present embodiment, the filters F1 and F2 pass the modulation signal Sₑₘ and block the first criterion signal S_{eb}. Further, the filters F3 and F4 pass the first criterion signal S_{eb} and block the modulation signal Sₑₘ.

For example, as the modulation signal Sₑₘ generated by the function generator FGm and the first criterion signal S_{eb} generated by the function generator FGb, sine waves having different frequencies can be used. For example, there is a likelihood that the first criterion signal S_{eb} and the modulation signal Sₑₘ are distorted for some reason, and respective harmonics are generated. Considering this possibility, it is desirable for the frequency of each signal not to match a frequency of harmonics of the frequency of the other signal.

As a specific example, when a frequency of the modulation signal Sₑₘ is 30 [MHz] and a frequency of the first criterion signal S_{eb} is 11 [MHz], the harmonic of the first criterion signal S_{eb} is an integral multiple of it [MHz] and it can be said that the harmonic does not become the frequency ( 30 [MHz]) of the modulation signal Sₑₘ.

Thus, when the modulation signal Sₑₘ and the first criterion signal S_{eb} are sine wave signals, a frequency filter can be used as the filters F1, F2, F3, and F4. Specifically, the filters F1 and F2 can be filters that use the frequency of the modulation signal Sₑₘ as a center frequency and cut the frequency of the first criterion signal S_{eb}. The filters F3 and F4 can be filters that use the frequency of the first criterion signal S_{eb} as a center frequency and cut the frequency of the modulation signal Sₑₘ.

For example, when [Frequency of modulation signal Sₑₘ]>[Frequency of first criterion signal S_{eb}], a high-pass filter in which cutoff is set to [(frequency of modulation signal Sₑₘ+frequency of first criterion signal S_{eb})/2] can be provided in the filters F1 and F2, and a low-pass filter can be provided in the filters F3 and F4.

Further, as another example, a bandpass filter can be used as the filters F1, F2, F3, and F4. Specifically, the filters F1 and F2 may be bandpass filters that use the frequency of the modulation signal Sₑₘ as a center frequency and do not pass signals having the frequency of the first criterion signal S_{eb} and an integral multiple of the frequency thereof (a frequency of the harmonic of the first criterion signal S_{eb}), and the filters F3 and F4 are bandpass filters that use the frequency of the first criterion signal S_{eb} as a center frequency and do not pass signals having the frequency of the modulation signal Sₑₘ and an integral multiple of the frequency thereof (the frequency of the harmonic of the modulation signal Sₑₘ). Further, when the bandpass filters are narrow band filters, noise or signal distortion (such as distortion appearing as harmonics of an original signal) can be removed, which contributes to high accuracy of distance measurement.

Further, signals orthogonal to each other can be used as the modulation signal S em and the first criterion signal S_{eb} described above. In an example of the sine wave signal, the modulation signal Sₑₘ and the first criterion signal S_{eb} are orthogonal to each other. Specific examples of orthogonal signals may include Haar transform nuclei, Walsh transform nuclei, Hadamard transform nuclei, and orthogonal wavelet nuclei.

In the signals orthogonal to each other, there are a number of conversion nuclei corresponding to the number of pieces of data, and for example, when there are N pieces of discrete data included in a digital signal, there are N nuclei. Two nuclei can be selected from among these nuclei and used in correspondence to the modulation signal Sₑₘ and the first criterion signal S_{eb}. In this case, the filters F1, F2, F3, and F4 are filters that separate the modulation signal Sₑₘ and the first criterion signal S_{eb}.

Next, a functional configuration of the skew measurement unit 112 will be described.

The skew measurement unit 112 measures a time difference between the two channels CH1 and CH2 of the ADC 110, that is, a skew between the channels. More specifically, the skew measurement unit 112 acquires a time of the peak of the second criterion signal S_{br} (a third peak time of a third peak) output from the filter F3, and obtains a time difference (a second time difference) from a time of a peak (a fourth peak time of a fourth peak) of the third criterion signal S_{bs} output from the filter F4 corresponding to such a peak. The second criterion signal S_{br} is a signal separated from the third reference signal Sᵣ +b output from the channel CH1, and the third criterion signal S_{bs} is a signal separated from the third detection signal S_{s+b} output from the channel CH2.

It is conceivable that, when the skew measurement unit 112 measures the skew between the channels CH1 and CH2 of the ADC no in a range of a polarization angle θ in which the light is one-dimensionally deflected by the optical deflector 104 as illustrated in FIG. 1, the distance measurement unit 113 obtains the distance to the object 105 for each finer angle. In the present embodiment, the skew measurement unit 112 measures the skew between the channels CH1 and CH2 for each peak of the second criterion signal S_{br}. When the skew of the time located between peaks is desired, a skew obtained at a peak position by the skew measurement unit 112 I is used for an interpolation unit 130 to be described below to interpolate the skew and to obtain the skew at a desired time.

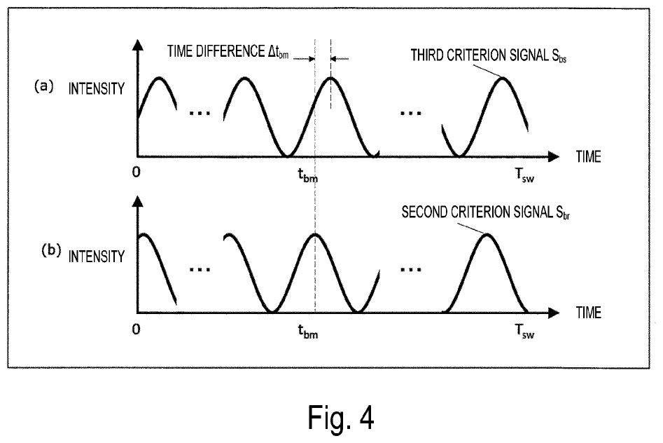

Next, an operation of the skew measurement unit 112 will be described with reference to FIG. 4. (a) of FIG. 4 illustrates a time waveform of the third criterion signal S_{bs} separated by the filter F4. (b) of FIG. 4 illustrates a time waveform of the second criterion signal S_{br} separated by the filter F3. In the example of FIG. 4, a case in which the first criterion signal S_{eb} output from the function generator FGb is a sine wave is shown.

The number of peaks at which the skew measurement unit 112 measures the skew is expressed as about N_{bp}=T_{sw}/T_{b}, in which T_{b} is a period of optical modulation of the second criterion signal S_{br} and T_{sw} is a scanning period of the optical deflector 104 (FIG. 4).

A time at which the optical deflector 104 starts to deflect light is set to t=o, and a time of an mth peak from the time t=o is set to t bm. A position corresponding to a broken line common to the waveforms of FIG. 4 is a time t bm of the mth peak of the second criterion signal S_{br}. When the difference from the peak times of the third criterion signal S_{bs} in a range of ±T_{b}/2 from this time t_{bm} is Δt_{bm} ((a) of FIG. 4), the skew measurement unit 112 obtains a time difference Atbin between the peak times as a skew between the channels CH1 and CH2.

The skew measurement unit 112 outputs data in which time t bm is associated with the time difference Δt_{bm} indicating the skew at time t_{bm}, as the skew signal Tₛₖ, m as illustrated in FIG. 1.

Next, a functional configuration of the distance measurement unit 113 will be described.

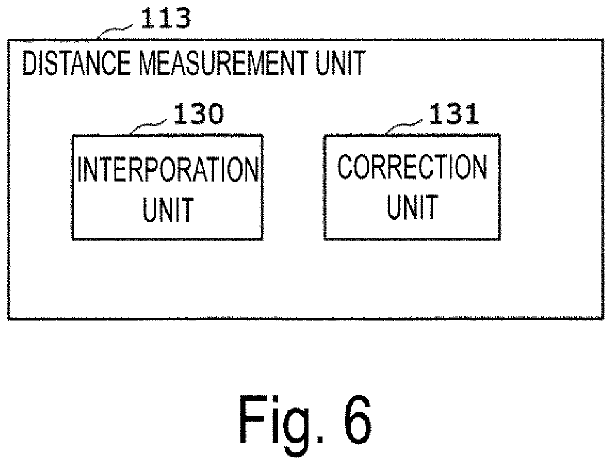

As illustrated in FIG. 6, the distance measurement unit 113 includes the interpolation unit 130 and a correction unit 131.

The distance measurement unit 113 receives the fourth reference signal Sᵣ and the fourth detection signal Sₛ separated by the filters F1 and F2, and the skew signal T_{sk, m} obtained by the skew measurement unit 112 as inputs, and obtains the distance from the distance measurement device 1 to the object 105. More specifically, the distance measurement unit 113 corrects the skew between the channels CH1 and CH2, that is, a timing difference between the fourth reference signal Sᵣ and the fourth detection signal Sₛ, and obtains the distance from the distance measurement device 1 to the object 105 at a time of a peak (the first peak time of the first peak) of the fourth reference signal Sᵣ based on the reference signal.

It is conceivable that, when the distance measurement unit 113 performs distance measurement in the range of the angle in which the light is one-dimensionally deflected by the optical deflector 104, the distance measurement unit 113 performs the distance measurement at each finer angl θ. In the present embodiment, it is assumed that the distance to the object 105 is calculated for each peak of the fourth reference signal Sᵣ based on the reference signal. When the distance to the object 105 between the peaks is desired, a calculated distance between peak positions is used for interpolation to obtain a more detailed distance.

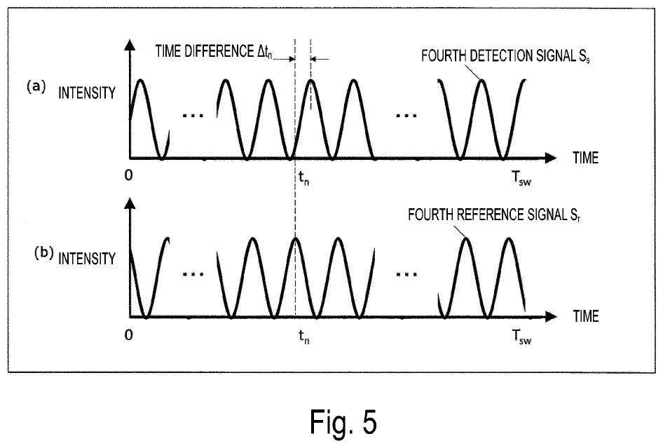

Regarding the number of peaks of the fourth reference signal Sᵣ, when a period of light modulation of the light of the light source 100 optically modulated by the light intensity modulator 101 is Tₘ and a period of scanning of the optical deflector 104 is T_{sw} as described above, the number of peaks is expressed as about Nₚ=T_{sw}/Tₘ. It is assumed that a start time of deflection of the optical deflection 104 is t=o, and a time of an nth peak from time t =o is tₙ. A position corresponding to a broken line commonly shown in a waveform of FIG. 5 is time to of the nth peak of the fourth reference signal Sᵣ. It is assumed that a difference (first time difference) from a peak time of the peak (a second peak time of a second peak) of the fourth detection signal Sₛ in a range of ±Tₘ/2 from this time Δtₙ ((a) of FIG. FIG. 5).

A skew between channels of the ADC no is included in this time difference Δtₙ. Thus, the distance measurement unit 113 subtracts the skew between channels from the time difference Δtₙ to perform the correction.

The interpolation unit 130 interpolates the skew signal T_{sk, m} measured by the skew measurement unit 112 to generate an interpolation curve. More specifically, the interpolation unit 130 interpolates discrete data having the time difference At bm indicating the skew at time t_{bm}, which is included in the skew signal T_{sk, m}.

The correction unit 131 extracts a time difference At b(t.) indicating the skew at time to from the interpolation curve of the skew signal T_{sk, m} generated by the interpolation unit 130. Further, the correction unit 131 subtracts the time difference Δt_{b}(tₙ) indicating the skew from the time difference Δtₙ between the fourth reference signal Sᵣ and the fourth detection signal Sₛ at time to according to Equation (1) below, corrects the time difference Δtₙ, and obtains the time difference Δt_{cor, n} after correction.

$$Δ {t}_{cor , n} = Δ {t}_{n} - Δ {t}_{b} ( {t}_{n} ) \qquad ( 1 )$$

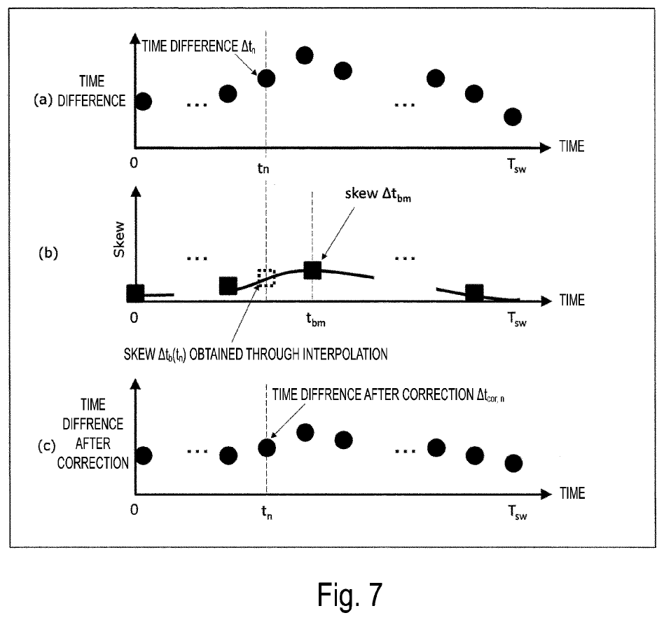

Here, operations of the distance measurement unit 113, the interpolation unit 130, and the correction unit 131 will be described with reference to FIG. 7. (a) of FIG. 7 illustrates a relationship between a time and the time difference Δtₙ from the peak time of the fourth detection signal Sₛ based on the peak time to of the fourth reference signal Sᵣ, which is calculated by the distance measurement unit 113. (b) of FIG. 7 illustrates the time difference Δt_{bm} indicating the skew obtained by the skew measurement unit 112 and the interpolation curve generated by the interpolation unit 130 interpolating the skew. (c) of FIG. 7 illustrates a relationship between the time difference Δt_{cor, n} corrected by the correction unit 131 and the time.

As described above, the frequency of the modulation signal S en, is set to be higher than the frequency of the first criterion signal S o), and a period T. of the fourth reference signal Sᵣ (FIG. 5) differs from a period T b of the second criterion signal S_{br} (FIG. 4). It is conceivable that, as illustrated in FIG. 7, in general, time tn when the distance measurement unit 113 obtains the time difference Δtₙ and time t bm when the skew measurement unit 112 obtains the time difference At bm are shifted from each other.

As illustrated in (b) of FIG. 7, the interpolation unit 130 interpolates the time difference At bm of the discrete data indicating the skew obtained by the skew measurement unit 112 to generate the interpolation curve. Further, as shown in a white plot (marker) of (b) of FIG. 7, the correction unit 131 extracts the time difference Δt_{b}(tₙ) indicating a skew at time tn based on the interpolation curve generated by the interpolation unit 130.

Further, as illustrated in (c) of FIG. 7, the correction unit 131 uses Equation (1) above to subtract the time difference Δt_{b}(tₙ) at time tn extracted from the interpolation curve from the time difference Δtₙ before correction obtained by the distance measurement unit 113 (FIG. 7 (a)) and to obtain the time difference Δt_{cor, n} A after correction at time tₙ.

The distance measurement unit 113 obtains a distance Lₙ from the coupler 102 to the object 105 that is measured at time tₙ from the time difference Δt_{cor, n} after correction obtained by the correction unit 131, using Equation (2) below. Here, c is a speed of light.

Lₙ=cΔt_{cor, n}/2 (2)

The time-angle conversion unit 114 replaces a time when the peak of the fourth reference signal Sᵣ appears, that is, a time corresponding to the distance signal Lₙ calculated from the time difference Δt_{cor, n} after correction with the deflection angle.

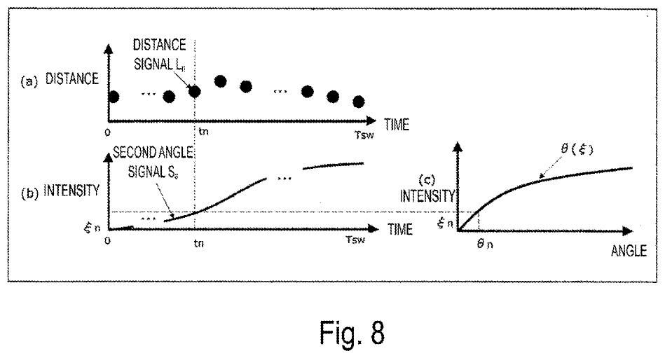

For example, it is assumed that the intensity of the second angle signal Sₙ, which is a digital angle signal at time tₙ, is ξₙ, as illustrated in (a) and (b) of FIG. 8. The time-angle conversion unit 114 substitutes the intensityn of the second angle signal Sₐ based on the deflection angle θ of the optical deflector 104 into a previously obtained conversion curve θ(ξ) illustrated in (c) of FIG. 8 to obtain the deflection angl θₙ=θ(ξₙ) corresponding to the intensity ξₙ. The time-angle conversion unit 114 outputs deflection angle-distance data (angle-distance signal) L_{angle, n} in which the deflection angle 0n is associated with the distance signal Lₙ.

The conversion curve O(R) illustrated in (c) of FIG. 8 illustrates a relationship between the intensity of the second angle signal Sₐ based on the angle signal and the deflection angle. The time-angle conversion unit 114 obtains deflection angles at the times of all the peaks included in the fourth reference signal Sᵣ and outputs the deflection angle-distance data corresponding to each deflection angle.

The time-angle conversion unit 114 can obtain the deflection angle-distance data in which the deflection angle at the deflection angle (time) included between the peaks of the fourth reference signal Sᵣ is associated with the distance signal Lₙ through interpolation. The time-angle conversion unit 114 may output data of the distance for a more detailed deflection angle (time) included between the peaks of the fourth reference signal Sᵣ as a deflection angle-distance data L′_{angle}, n after correction. Thus, it is possible to obtain data indicating a closer distance in time (angle).

### Hardware Configuration of Signal Processing Device

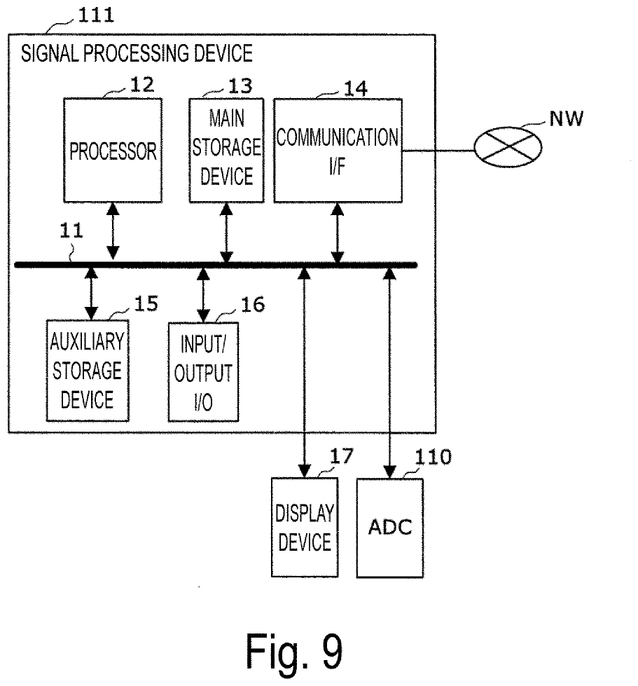

Next, an example of a hardware configuration of the signal processing device 111 having the above-described function will be described with reference to a block diagram of FIG. 9.

As illustrated in FIG. 9, the signal processing device 111 can be realized, for example, by a computer including a processor 12, a main storage device 13, a communication I/F 14, an auxiliary storage device 15, and an input and output I/O 16 connected via a bus 11, and a program that controls these hardware resources. The signal processing device 111 may be connected to, for example, a display device 17 via the bus 11, and display a deflection angle-distance data L_{angle, n} output from the time-angle conversion unit 114 or the deflection angle-distance data L′_{angle}, n after interpolation output from the time-angle conversion unit 114 on the display screen. Further, for example, the ADC 110, the function generators FGm and FGb, the ADr 108, the ADs 109, and the optical system OS of the distance measurement device 1 are connected via the bus 11 or the input and output I/O 16.

The main storage device 13 is realized by, for example, a semiconductor memory such as a SRAM, a DRAM, and a ROM. A program for causing the processor 12 to perform various controls or calculations is stored in the main storage device 13 in advance. Each function of the signal processing device iii including the filters F1, F2, F3, and F4, the skew measurement unit 112, the distance measurement unit 113, and the time-angle conversion unit 114 illustrated in FIG. 1 is implemented by the processor 12 and the main storage device 13. Further, setting or control of the optical system OS, the ADC 110, or the like can be performed by the processor 12 and the main storage device 13.

The communication I/F 14 is an interface circuit for performing communication with various external electronic devices via a communication network NW. The signal processing device 111 may transmit, for example, the deflection angle-distance data L_{angle, n}, or the like to the outside via the communication I/F 14.

As the communication I/F 14, for example, an interface and an antenna compatible with wireless data communication standards such as LTE, 3G, 5G, wireless local area network (LAN), and Bluetooth (registered trademark) are used. The communication network NW includes, for example, wide area network (WAN), a local area network (LAN), the Internet, a dedicated line, a wireless base station, and a provider.

The auxiliary storage device 15 is configured of a readable and writable storage medium, and a drive device for reading or writing various types of information such as programs or data from or to the storage medium. A hard disk or a semiconductor memory such as a flash memory can be used as a storage medium in the auxiliary storage device 15.

The auxiliary storage device 15 has a program storage area for storing a program for causing the signal processing device 111 to perform a filtering process, a skew measurement process, a distance measurement process, a correction process, a conversion process, and an interpolation process. Further, the auxiliary storage device 15 may have, for example, a backup area for backing up the data, programs, and the like described above.

The auxiliary storage device 15 stores a conversion curve that the time-angle conversion unit 114 uses for a conversion process. Further, the auxiliary storage device 15 stores the period Tₘ of the fourth reference signal Sr. Further, the auxiliary storage device 15 stores the period T_{b} of the second criterion signal S br.

The input and output I/O 16 is configured of an I/O terminal for inputting a signal from an external device such as the display device 17 or outputting a signal to an external device.

The signal processing device 111 may be realized by one computer or may be distributed by a plurality of computers connected to each other via the communication network NW. Further, the processor 12 may be realized by hardware such as a field-programmable gate array (FPGA), a large scale integration (LSI), and an application specific integrated circuit (ASIC).

### Operation of Distance Measurement Device

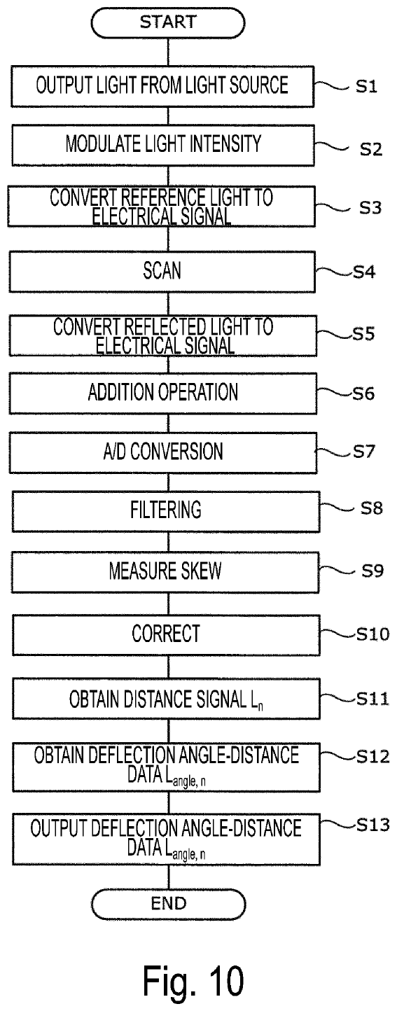

Next, an overall operation of the distance measurement device 1 having the above-described configuration will be described with reference to the flowchart of FIG. 10.

First, light is emitted from the light source too (step S1). For the light source too, for example, a CW light source is used. Then, the light intensity modulator tot periodically modulates the light intensity of the light emitted from the light source 100 with a sine wave or the like (step S2). Specifically, the light intensity modulator tot uses, for example, the modulation signal Sₑₘ of a sine wave generated by the function generator FGm to modulate the light intensity of the light of the light source 100 with the sine wave, and outputs the modulated light.

The light that is emitted from the light source 100 and of which the intensity has been periodically modulated by the light intensity modulator 101 is split into a reference optical path side and an object optical path side by the coupler 102. The reference light on the reference optical path side is received by the PDr 106 and photoelectrically converted, and the first reference signal Sₑᵣ is output (step S 3). On the other hand, the light on the object optical path side is deflected by the optical deflector 104 via the circulator 103, and the space around the object 105 is scanned with the light with a scan period as T_{sw} (step S 4).

Next, when the inside of the space is scanned once with the light deflected by the optical deflector 104, the object 105 is irradiated with the light, the reflected light is received by the PDs 107 via the optical deflector 104 and the circulator 103 and converted to an electric signal through photoelectric conversion, and the first detection signal Sₑₛ is output (step S1).

Next, each of the ADr 108 and the ADs 109 adds two input signals and outputs an added signal (step S6). More specifically, the ADr 108 adds the first criterion signal S_{eb} generated by the function generator FGb to the first reference signal Sₑᵣ output from PDr 106, and outputs the second reference signal S_{er+eb}. On the other hand, the ADs 109 adds the first criterion signal S_{eb} generated by the function generator FGb to the first detection signal Sₑₛ output from PDs 107, and outputs the second detection signal S_{es+eb}.

Thereafter, the ADC 110 converts the analog signals input to the channels CH1, CH2, and CH3 to digital signals (step S7). More specifically, the second analog reference signal S_{er+eb} is input to the channel CH1 of the ADC 110 and converted to the third digital reference signal S_{r+b}. The second analog detection signal S_{es+eb} based on the reflected light from the object 105 is input to the channel CH2 of the ADC 110 and converted to the third digital detection signal S_{s+b}. Further, the first analog angle signal Sₑₐ indicating the deflection angle θ is input to the channel CH3 of the ADC 110 and converted to the second digital angle signal Sₐ.

Then, in the signal processing device in, each of the filters F1, F2, F3, and F4 filters the signals input from the ADC 110 (step S8). Specifically, the third reference signal S_{r+b} is input from the channel CH1 to the filters F1 and F3. The filter F1 separates to extract the fourth reference signal Sᵣ from the third reference signal S_{r+b}. The filter F3 separates to extract the second criterion signal S_{br} from the third reference signal S_{r+b}.

On the other hand, the third detection signal S_{s+b} is input from the channel CH2 to the filters F2 and F4. The filter F2 separates to extract the fourth detection signal Sₛ from the third detection signal Sₛ, b. The filter F4 separates to extract the third criterion signal S_{bs} from the third detection signal S_{s+b}.

The fourth reference signal Sᵣ and the fourth detection signal Sₛ separated by the filters F1 and F2 are input to the distance measurement unit 113. The second criterion signal S br and the third criterion signal S_{bs} separated by the filters F3 and F4 are input to the skew measurement unit 112.

Then, the skew measurement unit 112 measures the skew between the channels CH1 and CH2 of the ADC no and outputs the skew signal T_{sk, m} (step S9). More specifically, the skew measurement unit 112 obtains the time difference Δt_{bm} from the peak time of the third criterion signal S_{bs} in a range of ±T_{b}/2 from time t_{bm} of each peak based on the period T_{b} of the second criterion signal S_{br} as a skew (FIG. 4). The skew measurement unit 112 outputs the skew signal T_{sk, m} in which time t bm is associated with the time difference Δt_{bm}.

Next, the distance measurement unit 113 corrects the skew between the channels CH1 and CH2 based on the skew signal T_{sk, m} between the channels CH1 and CH2 input from the skew measurement unit 112 (step S10).

More specifically, the distance measurement unit 113 uses the period Tₘ of the fourth reference signal Sᵣ to obtain the time difference Δtₙ from the peak time of the fourth detection signal Sₛ in a range of ±Tₘ/2 from time to of each peak (FIG. 5). The fourth reference signal Sᵣ is a signal obtained by the filter F1 filtering the signal subjected to the AD-conversion on the channel CH1. The fourth detection signal Sₛ is a signal obtained by the filter F2 filtering the signal subjected to the AD-conversion on the channel CH2.

In step S10, the interpolation unit 130 performs interpolation on the skew signal T_{sk, m} between the channels CH1 and CH2 obtained for each peak time t_{bm} of the second criterion signal S_{br} to generate an interpolation curve.

Further, in step S10, the correction unit 131 extracts the time difference Δt_{b}(tₙ) indicating the skew at time to from the interpolation curve. The correction unit 131 subtracts the time difference Δt_{b}(tₙ) indicating skew from the time difference Δtₙ according to Equation (1) above to correct the time difference Atn, and outputs the time difference Δt_{cor, n} after correction.

Thereafter, the distance measurement unit 113 uses the time difference Δt_{b}(tₙ) in which the skew between the channels CH1 and CH2 is corrected by the correction unit 131 to calculate the distance signal Lₙ from Equation (2) above (step S11).

Next, the time-angle conversion unit 114 converts time to corresponding to the distance signal Lₙ obtained in step S11 to an angle (step S12). More specifically, the time-angle conversion unit 114 replaces the peak time of the fourth reference signal Sᵣ obtained by the distance measurement unit 113, that is, time tₙ corresponding to the distance signal Lₙ calculated after correction of the skew between the channels with the deflection angle θ, and outputs the deflection angle-distance data L_{angle, n} in which the deflection angle θₙ is associated with the distance signal Lₙ.

Specifically, the time-angle conversion unit 114 reads the conversion curve θ(ξ) illustrated in (c) of FIG. 8 stored in the auxiliary storage device 15 or the like in advance, and substitutes the intensity ξₙ of the second angle signal Sₐ at time tₙ into the conversion curve θ(ξ) to convert time to to the deflection angle θₙ=θ(ξₙ). Further, the time-angle conversion unit 114 obtains the deflection angle-distance data L_{angle, n} in which the deflection angle θₙ is associated with the distance signal Lₙ.

Thereafter, the time-angle conversion unit 114 outputs the deflection angle-distance data L_{angle, n} (step S13). For example, the display device 17 can display the deflection angle-distance data L_{angle, n} output from the time-angle conversion unit 114 on the display screen. Further, the display device 17 may display the skew signal T_{sk, m} or other data on the display screen.

The time-angle conversion unit 114 may interpolate the value between the peaks of the fourth reference signal Sᵣ from the deflection angle-distance data L_{angle, n} obtained in step S12.

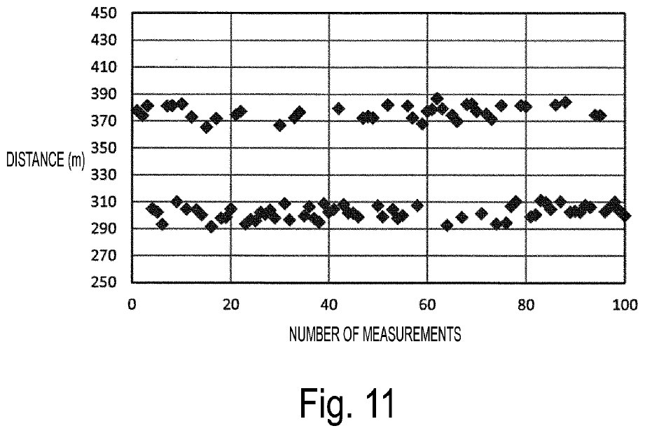

Next, the distances to the object 105 before and after the correction of the skew between the channels at a certain time (deflection angle) processed by the signal processing device tit according to the present embodiment are illustrated in FIGS. 11 to 14.

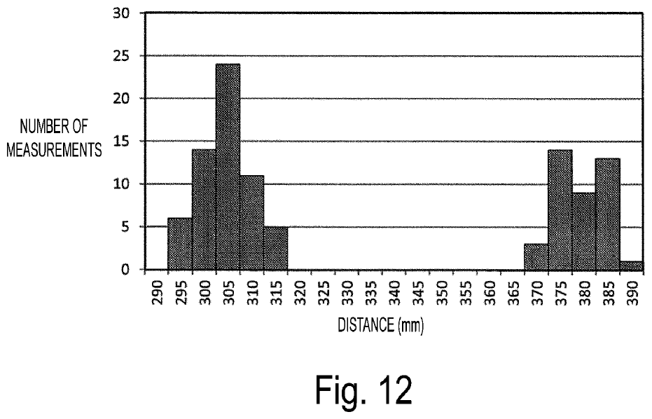

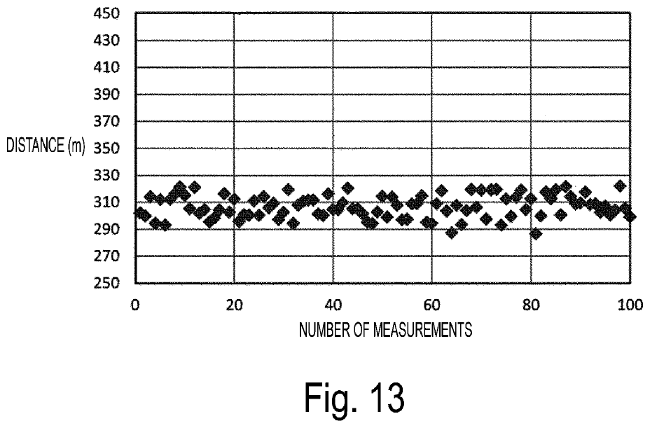

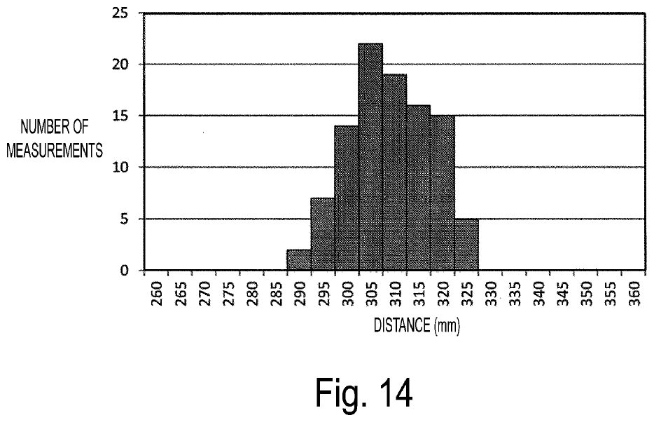

FIGS. 11 and 12 illustrate the distance to the object 105 that is a measurement target before correction. FIGS. 13 and 14 illustrate the distance to the object 105 after correction. FIGS. 11 and 13 are plots of measured values of the distance to the object 105 at each of measurements when the measurement is repeated 100 times. FIGS. 12 and 14 illustrate measured values of the distance in histograms.

In measurement examples illustrated in FIGS. 11 to 14, in the ADC 110, a temporal fluctuation of the skew between the channel CH2 to which the first detection signal Sₑₛ is input and the channel CH1 to which the first reference signal Sₑᵣ is input was polarized, and a difference therebetween was about 0.5 [ns]. Thus, a difference between the distances before and after correction is about 7.5 [cm] (=3×10⁸×0.5×10⁻⁹/2 [m]), as illustrated in FIGS. 11 and 12.

The signal processing device tit according to the present embodiment performs the measurement and correction process of the skew between the channels CH1 and CH2, thereby obtaining an effect of eliminating the polarization in the value of distance, as illustrated in FIGS. 13 and 14. A standard deviation was 3.6952 [cm] before correction, but became 0.8488 [cm] after correction, which was a reduction to about 23% of the standard deviation before correction. Thus, it is possible to improve measurement accuracy of the distance by performing the correction process.

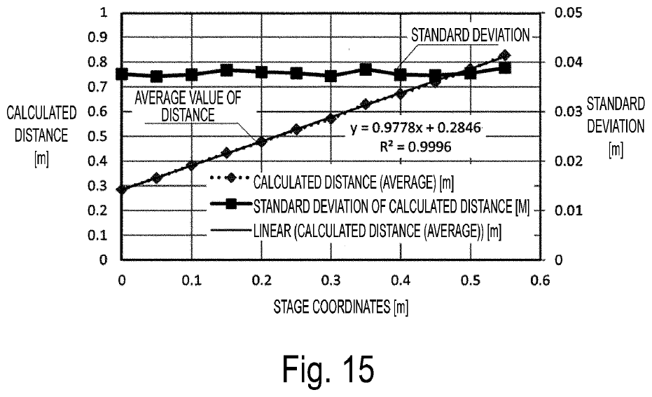

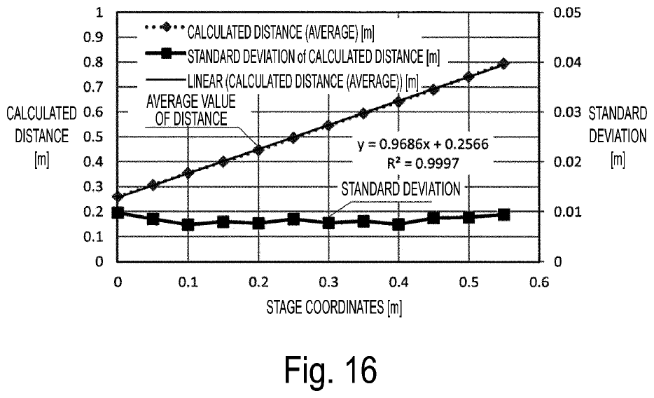

FIGS. 15 and 16 illustrate results of measuring the distance while shifting a moving stage on which the object 105 is placed from 0 [cm] to 55 [cm] in the distance measurement device 1 according to the present embodiment. Measurement was performed too times at each position of the moving stage on which the object 105 was placed, and an average value and a standard deviation of the distances before and after correction were obtained.

The standard deviation before correction illustrated in FIG. 15 was about 3.8 [cm], but the standard deviation after correction illustrated in FIG. 16 was reduced to about 1 [cm]. From this, it can be seen that the accuracy of the distance measurement is improved by performing the correction process of the signal processing device tit according to the present embodiment.

As described above, with the distance measurement device 1 according to the present embodiment, the skew signal T_{sk, m} measured by the skew measurement unit 112 is used for correction of a time difference between the peak time included in the waveform of the fourth reference signal Sᵣ output from the channel CH1 of the ADC no and the corresponding peak time included in the waveform of the fourth detection signal Sₛ output from the channel CH2. The distance measurement device 1 calculates the distance to the object 105 for each peak time of the fourth reference signal Sᵣ based on the time difference in which the skew between the channels has been corrected. Thus, even when the skew between the channels of the ADC fluctuates with each signal acquisition, it is possible to measure the distance to the object with high accuracy.

Although the embodiments of the distance measurement device of the present invention have been described above, the present invention is not limited to the described embodiments, and various modifications that can be assumed by those skilled in the art can be made in the scope of the invention described in the claims.

For example, in the described embodiment, the example in which, in the signal processing device in, the time-angle conversion unit 114 converts the distance signal Lₙ to the deflection angle-distance data L_{angle, n}, and then the time-angle conversion unit 114 performs the interpolation process has been described. However, for example, the distance measurement unit 113 may execute the interpolation process before the conversion process of the time-angle conversion unit 114. In this case, for example, the distance measurement unit 113 performs interpolation between the peaks of the fourth reference signal Sᵣ based on the distance signal Lₙ, and then converts the time into a deflection angle.

When the interpolation process is performed before a time-angle conversion process, the peak time of the fourth reference signal Sᵣ acquired by the distance measurement unit 113 cannot be used as it is as time information required for the conversion process. This is because the number of distances obtained by the distance measurement unit 113 (equal to the number of times obtained by the distance measurement unit 113) differs from the number of distances output through the interpolation process. Thus, in the interpolation process, the peak time of the fourth reference signal Sᵣ acquired by the distance measurement unit 113 is used for calculation of the time corresponding to the distance information obtained through the interpolation, and the time is used for the time-angle conversion unit 114 converting the time to the angle.

Further, in the embodiments described so far, a case in which the light output from the light intensity modulator 101 is light of which the intensity has been periodically modulated by a sine wave or the like has been described. However, a wavelength sweep light source may be used as the light source too, and the wavelength sweep light source having a periodic intensity modulation function may be implemented by the light source too and the light intensity modulator tot. In this case, a passive optical element such as a transmission type or reflection type diffraction grating or a prism made of a material having a large refractive index dispersion is used as the optical deflector 104. Even when the wavelength sweep light source having a periodic intensity modulation function is adopted, it is possible to use a spatial light modulator as the optical deflector 104.

In this case, a lattice constant of the diffraction grating, or the like can be designed to be deflected in a desired range of angle depending on a wavelength of the light of the light source too, a maximum distance required for measurement, a size of the distance measurement device 1, and the like. Further, for a refractive index or wavelength dispersion thereof of the prism, a material having a refractive index and a wavelength dispersion thereof can be selected for deflection at a desired angle as well. Further, in the light source too and the light intensity modulator tot, when the wavelength sweep light source having a periodic intensity modulation function is adopted, the first angle signal Sₑₐ indicating the deflection angle is configured to be linked to a wavelength of the light output from the light intensity modulator 101.

An example of an advantage when the light source too and the light intensity modulator 101 are performed as the wavelength sweep light source having a periodic intensity modulation function and the optical deflector 104 is used as the passive optical element such as a diffraction grating or a prism is that it is possible to eliminate a need for parts requiring a mechanical operation in the optical deflector 104. From this, for example, when an optical system included in the distance measurement device 1 is separated into the optical deflector 104 and the other, the optical deflector 104 is used as a probe, the other is used as a main body, and the probe and the main body are connected by an optical fiber, the probe can be miniaturized. Thus, the distance measurement device 1 can be installed in a narrow place or the like, or a person can easily carry a probe portion to perform measurement. Further, because the probe has no mechanically operating parts, the probe has high resistance to vibration. Thus, it is possible to perform accurate measurement even in an environment with severe vibration by separating the main body and the probe from each other and evacuating the main body to a place at which vibration is weak.

### REFERENCE SIGNS LIST

1 Distance measurement device

100 Light source

101 Light intensity modulator

102 Coupler

103 Circulator

104 Optical deflector

105 Object

106 Photodetector PDr

107 Photodetector PDs

108 Adder ADr

109 Adder Ads

110 ADC

111 Signal processing device

F1, F2, F3, F4 Filter

112 Skew measurement unit

113 Distance measurement unit

114 Time-angle conversion unit

FGm, FGb Function generator

11 Bus

12 Processor

13 Main storage device

14 Communication I/F

15 Auxiliary storage device

16 Input and output I/O

17 Display device

1.-7. (canceled)

8. A distance measurement device comprising:
a first photodetector configured to receive a part of light of which an intensity has been periodically modulated as reference light and convert the light to a first reference signal;
a second photodetector configured to detect reflected light obtained by the light being reflected from a surface of an object serving as a measurement target and convert the reflected light to a first detection signal;
an adder configured to add a first criterion signal to each of the first reference signal and the first detection signal and to output a second reference signal and a second detection signal;
an analog-to-digital converter comprising a first channel and a second channel, the first channel configured to perform analog-to-digital conversion on the second reference signal and output a third digital reference signal, the second channel configured to perform analog-to-digital conversion on the second detection signal and output a third digital detection signal; and
a signal processing circuit configured to:
extract a fourth reference signal based on the reference light and a second criterion signal based on the first criterion signal from the third digital reference signal;
extract a fourth detection signal based on the reflected light and a third criterion signal based on the first criterion signal from the third digital detection signal;
measure a skew and output a skew signal indicating the measured skew, the skew being a timing difference between the first channel and the second channel based on the second criterion signal and the third criterion signal;
correct, using the skew signal, a first time difference between a first peak time of a first peak included in a waveform of the fourth reference signal and a second peak time of a second peak included in a waveform of the fourth detection signal, the second peak corresponding to the first peak; and
obtain a distance to the object for each first peak time based on the corrected first time difference and output a distance signal.

9. The distance measurement device of claim 8, wherein the signal processing circuit is further configured to:
measure, as the skew, a second time difference between a third peak time of a third peak included in a waveform of the second criterion signal and a fourth peak time of a fourth peak included in a waveform of the third criterion signal, the fourth peak corresponding to the third peak; and
output the skew for each third peak time as the skew signal.

10. The distance measurement device of claim 8, wherein the skew signal is a discrete signal, and the signal processing circuit is further configured to:
interpolate the discrete signal to generate an interpolation curve;
extract an interpolated skew at the first peak time from the interpolation curve; and
subtract the interpolated skew at the first peak time from the first time difference to correct the first time difference.

11. The distance measurement device of claim 8 further comprising:
a light intensity modulator configured to periodically modulate the intensity of the light from a light source and output resultant light;
an optical splitter configured to split the light from the light intensity modulator; and
an optical deflector configured to deflect the light output from a first side of the optical splitter and emit the light toward the object,
wherein the first photodetector is configured to receive the reference light output from a second side of the optical splitter, and to convert the reference light to the first reference signal, and
wherein the second photodetector is configured to detect reflected light resulted from the emitted light emitted from the optical deflector being reflected on the surface of the object, and to convert the reflected light to the first detection signal.

12. The distance measurement device of claim ii, wherein the signal processing circuit is further configured to:
convert the first peak time of the distance signal obtained for each first peak time to information on a deflection angle of the optical deflector; and
output an angle-distance signal in which the deflection angle is associated with the distance.

13. The distance measurement device of claim 8, wherein a frequency of a modulation signal with which the intensity of the light has been periodically modulated differs from a frequency of the first criterion signal.

14. The distance measurement device of claim 8, wherein the distance signal is a discrete signal, and the signal processing circuit is further configured to:
perform interpolation of the discrete signal based on the distance signal indicating the distance to the object obtained for each first peak time.

15. A distance measurement device comprising:
a first photodetector configured to receive a part of light of which an intensity has been periodically modulated as reference light and convert the light to a first reference signal;
a second photodetector configured to detect reflected light obtained by the light being reflected from a surface of an object serving as a measurement target and convert the reflected light to a first detection signal;
an adder configured to add a first criterion signal to each of the first reference signal and the first detection signal and to output a second reference signal and a second detection signal;
an analog-to-digital converter comprising a first channel and a second channel, the first channel configured to perform analog-to-digital conversion on the second reference signal and output a third digital reference signal, the second channel configured to perform analog-to-digital conversion on the second detection signal and output a third digital detection signal; and
a signal processing device configured to:
extract a fourth reference signal based on the reference light and a second criterion signal based on the first criterion signal from the third digital reference signal;
extract a fourth detection signal based on the reflected light and a third criterion signal based on the first criterion signal from the third digital detection signal;
measure a skew comprising a timing difference between the first channel and the second channel based on the second criterion signal and the third criterion signal;
correct, using the skew, a first time difference between a first peak time of a first peak included in a waveform of the fourth reference signal and a second peak time of a second peak included in a waveform of the fourth detection signal, the second peak corresponding to the first peak; and
obtain a distance to the object for each first peak time based on the corrected first time difference and output a distance signal.

16. The distance measurement device of claim 15, wherein the signal processing device is further configured to:
measure, as the skew, a second time difference between a third peak time of a third peak included in a waveform of the second criterion signal and a fourth peak time of a fourth peak included in a waveform of the third criterion signal, the fourth peak corresponding to the third peak.

17. The distance measurement device of claim 15, wherein the skew comprises a discrete signal, and the signal processing device is further configured to:
interpolate the discrete signal to generate an interpolation curve;
extract an interpolated skew at the first peak time from the interpolation curve; and
subtract the interpolated skew at the first peak time from the first time difference to correct the first time difference.

18. The distance measurement device of claim 15 further comprising:
a light intensity modulator configured to periodically modulate the intensity of the light from a light source and output resultant light;
an optical splitter configured to split the light from the light intensity modulator; and
an optical deflector configured to deflect the light output from a first side of the optical splitter and emit the light toward the object,
wherein the first photodetector is configured to receive the reference light output from a second side of the optical splitter, and to convert the reference light to the first reference signal, and
wherein the second photodetector is configured to detect reflected light resulted from the emitted light emitted from the optical deflector being reflected on the surface of the object, and to convert the reflected light to the first detection signal.

19. The distance measurement device of claim 18, wherein the signal processing device is further configured to:
convert the first peak time of the distance signal obtained for each first peak time to information on a deflection angle of the optical deflector; and
output an angle-distance signal in which the deflection angle is associated with the distance.

20. The distance measurement device of claim 15, wherein a frequency of a modulation signal with which the intensity of the light has been periodically modulated differs from a frequency of the first criterion signal.

21. The distance measurement device of claim 15, wherein the distance signal is a discrete signal, and the signal processing device is further configured to:
perform interpolation of the discrete signal based on the distance signal indicating the distance to the object obtained for each first peak time.

22. A distance measurement method comprising:
receiving a part of light of which an intensity has been periodically modulated as reference light and convert the light to a first reference signal;
detecting reflected light obtained by the light being reflected from a surface of an object serving as a measurement target and converting the reflected light to a first detection signal;
adding a first criterion signal to each of the first reference signal and the first detection signal and outputting a second reference signal and a second detection signal;
converting the second reference signal to a third digital reference signal with a first channel of an analog-to-digital converter;
converting the second detection signal to a third digital detection signal with a second channel of the analog-to-digital converter;
extracting a fourth reference signal based on the reference light and a second criterion signal based on the first criterion signal from the third digital reference signal;
extracting a fourth detection signal based on the reflected light and a third criterion signal based on the first criterion signal from the third digital detection signal;
measuring a skew comprising a timing difference between the first channel and the second channel based on the second criterion signal and the third criterion signal;
correcting, using the skew, a first time difference between a first peak time of a first peak included in a waveform of the fourth reference signal and a second peak time of a second peak included in a waveform of the fourth detection signal, the second peak corresponding to the first peak; and
obtaining a distance to the object for each first peak time based on the corrected first time difference and outputting a distance signal.

23. The distance measurement method of claim 22 further comprising:
measuring, as the skew, a second time difference between a third peak time of a third peak included in a waveform of the second criterion signal and a fourth peak time of a fourth peak included in a waveform of the third criterion signal, the fourth peak corresponding to the third peak.

24. The distance measurement method of claim 22, wherein the skew comprises a discrete signal, and the distance measurement method further comprises:
interpolating the discrete signal to generate an interpolation curve;
extracting an interpolated skew at the first peak time from the interpolation curve; and
subtracting the interpolated skew at the first peak time from the first time difference to correct the first time difference.

25. The distance measurement method of claim 22, wherein a frequency of a modulation signal with which the intensity of the light has been periodically modulated differs from a frequency of the first criterion signal.

26. The distance measurement method of claim 22, wherein the distance signal is a discrete signal, and the distance measurement method further comprises:
performing interpolation of the discrete signal based on the distance signal indicating the distance to the object obtained for each first peak time.
